(19) United States
(12) Patent Application Publication
(10) Pub. No.: US 2005/0238825 A1
(43) Pub. Date: Oct. 27, 2005

(54) Crosslinked polymeric composition

(75) Inventors: David K. Hood, Basking Ridge, NJ (US); Jim Di Battista, Tucson, AZ (US)

Correspondence Address: INTERNATIONAL SPECIALTY PRODUCTS;Attn: William J. Davis, Esq., Legal Department, Building No. 8, 1361 Alps Road, Wayne, NJ, 07470, US

(73) Assignee: ISP INVESTMENTS INC.

(21) Appl. No.: 10/832,710

(22) Filed: Apr. 26, 2004

(51) Int. Cl. B41M 5/00

(52) U.S. Cl. 428/32.1

(57) ABSTRACT

A crosslinked polymeric composition of hydrolyzed poly(2-alkyl-2-oxazoline) is particularly useful for making high print quality color ink-jet films which are substantially water resistant.

### BACKGROUND OF THE INVENTION

1. Field of the Invention

This invention relates to polymeric compositions, and, more particularly, to crosslinked polymeric compositions of hydrolyzed poly (2-alkyl-2-oxazoline) which are useful in forming high print quality color ink-jet films which exhibit substantially improved water resistance.

2. Description of the Prior Art

The advent of color inkjet printing has been instrumental in fueling the print-on-demand revolution and has also created a number of challenges. Often, the surface of the desired media does not possess the necessary properties for accepting the ink-jet ink. This results in long dry times and/or a poor inkjet images. It has long been recognized that a surface treatment or media coating plays a critical role in the final print quality. Numerous media coatings are known in the art. They may contain any number of components and often consist of more than one layer. These ink-receptive coatings generally contain at least one hydrophilic polymer; such as poly(vinylpyrrolidone) (PVP) or poly (2-alkyl-2-oxazoline) (i.e., Aquazol®). Aquazol brings many benefits to properly formulated media coatings including improved absorption of inks and excellent adhesive properties. Furthermore, copolymers of vinylpyrrolidone (VP) along with other suitable comonomers, such as dimethylaminoethyl methacrylate, acrylic acid, or vinyl acetate, have been used separately or in conjunction with Aquazol, to further optimize coating performance. Unfortunately, Aquazol has very limited water resistance. It is desired to provide long-term, excellent water-resistant qualities for such films, and to improve their color ink-jet print qualities.

Poly (2-ethyl-2-oxazoline) (PEOX), also known as Aquazol® (Polymer Chemistry Innovations, Inc.) is a water-soluble N-acyl polyethyleneimine having a number average molecular weight of about 50,000. However, Aquazol itself does not provide good color ink-jet films, and is not easily cross-linked.

Accordingly, it is an object of this invention to provide a cross-linkable polymeric composition of hydrolyzed poly(2-alkyl-2-oxazoline) which, when treated with a cross-linker, can provide advantageous films which exhibit improved water resistance.

### SUMMARY OF THE INVENTION

What is described herein is a crosslinked polymeric composition of hydrolyzed poly(2-alkyl-2-oxazoline) which forms high print quality color ink-jet films which exhibit improved water resistance.

### DETAILED DESCRIPTION OF THE INVENTION

In a preferred form of the invention the poly(2-alkyl-2-oxazoline) is poly(2-ethyl-2-oxazoline) which is about 1-75%, preferably 5-30%, hydrolyzed in aqueous acid solution. This partially hydrolysis product is a linear polyethyleneimine (L-PEI) which is a random copolymer composed of a hydrolyzed unit of ethyleneimine and an unhydrolyzed unit of N-propronyl ethyleneimine. Removal of a portion of the side groups containing a residual from poly(2-alkyl-2-oxazoline) by hydrolysis enhances its crosslinkability to a crosslinked copolymer which has excellent printability properties.

The hydrolyzed copolymer is crosslinked at its ethyleneimine group with a suitable crosslinking agent such as an polyaziridine, polyepoxide, a melamine/formaldehyde, ammonium zirconium carbonate, polycarboxylic acid, polyaldehydes, and the like. Crosslinking can be affected prior to coating of the polymeric composition onto a film substrate or, optionally, by heating during the coating process itself.

The crosslinking step will form a 1-50% crosslinked copolymer composition in the form of an aqueous solution or a hydrogel.

The invention will now be described in more detail by reference to the following examples.

### EXAMPLE 1

A poly(2-ethyl-2-oxazoline), 1270 g was dissolved in 2.3 L of water in a 12 L, 3-necked flask equipped with a mechanical stirrer. Then 600 g of concentrated (12M) HCl was added slowly with stirring. The system was flushed with nitrogen and then kept under positive nitrogen pressure. Then the contents were heated to reflux with stirring. After 24 hrs, heating was stopped, the flask allowed to cool to room temperature, and the mixture was neutralized with NH₄OH to a pH of 7.0.

The product was 20% hydrolyzed poly(2-ethyl-2-oxazoline) which was aqueous solution of a copolymer of ethyleneimine and n-propronyl ethyleneimine. Propionic acid salt was present as the by product of the hydrolysis. If desired, the residual propionic acid can be removed by distillation or ion-exchange resin treatment, thus affording a substantially propionic-free product. The reaction proceeds as follows:

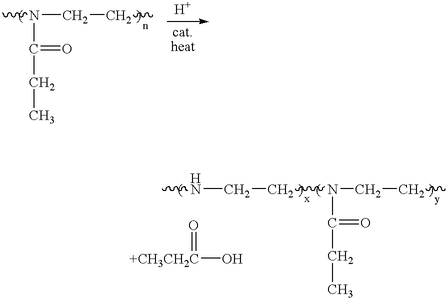

### EXAMPLE 2

A poly(2-ethyl-2-oxazoline), 1700 g was dissolved in 2.3 L of water in a 12 L, 3-necked flask equipped with a mechanical stirrer. To this solution was added 600 grams of a 48% solution of sodium hydroxide. The system was flushed with nitrogen and kept under a positive nitrogen pressure. The contents were heated to reflux and after 24 hrs the heating was stopped. The cooled solution was neutralized with HCl to a pH of 7.0.

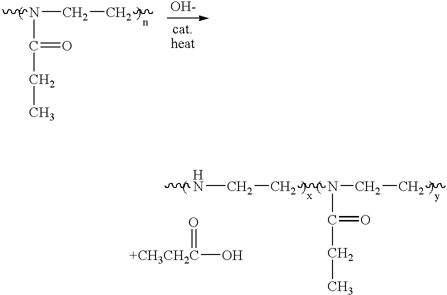

The product was similar to that obtained in Example 1.

### EXAMPLE 3

0.5 g of conc. HCl was added to 20 g of the aqueous solution of Example 1 followed by 3 g of conc. NH₄OH. Then 0.2 g of an aziridinic crosslinking agent (XAMA-7, Bayer) was added and thoroughly mixed at room temperature. The resulting solution was coated onto a Melanex® film using a #38 Meyer rod and dried at 100° C. until dry. The crosslinking reaction was effected in this manner after coating to provide the following crosslinked copolymer product.

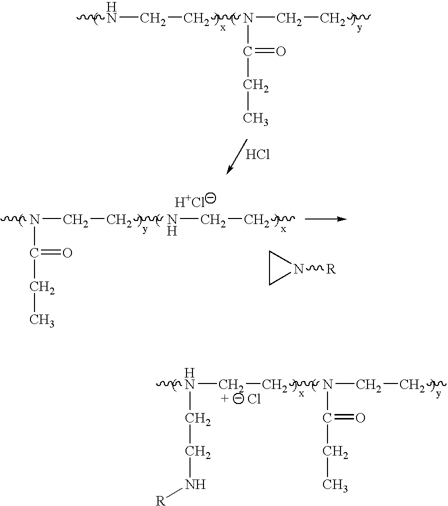

The thus-coated film was printed using HP 880C and Epson 890 printers in the photoglossy mode. For comparative purposes poly(2-ethyl-2-oxazoline) itself (unhydrolyzed and treated in similar fashion) was coated onto the film and printed in the same manner. The film were submerged in room temperature, agitated water for 30 minutes. The comparative results demonstrate that the crosslinked, hydrolyzed polymer of the invention yields color print images which exhibit improved water resistance.. The control product, however, was unable to resist exposure to water.

### EXAMPLE 4

200 grams (˜10% solids) of product in Example 1 is treated with 1 gram of Heloxy® 67 (Resolution Performance Products) which is the diglycidyl ether of 1,4 butanediol. After 24 hours at room temperature, solution had formed a gel. For comparative purposes, 200 grams (˜10% solids) of Aquazol 200 is treated with 1 gram of Heloxy 67. After,24 hours at room temperature, the solution exhibited as viscosity of 27.8 cPs at 13.9% scale (Brookfield LVT, (6)1, 30 RPM). No gel was observed.

While the crosslinked polymeric composition of hydrolyzed poly(2-alkyl-2-oxazoline) can be used as a film former by itself, it may be desirable to form admixtures of it with other film-forming polymers. Suitable admixtures are made with such polymers as polyvinyl alcohol, polyvinylpyrrolidone, cellulose, gelatin, as well as polyurethanes, latexes, and the like. These admixtures can further enhance print quality as well as the water resistance of the product.

While the invention has been described with particular reference to certain embodiments thereof, it will be understood that changes and modifications may be made which are within the skill of the art. Accordingly, it is intended to be bound only by the following claims, in which:

1. A crosslinked polymeric composition of hydrolyzed poly(2-alkyl-2-oxazoline).

2. A composition according to claim 1 wherein poly(2-alkyl-2-oxazoline) is partially hydrolyzed in an amount of about 1-75%.

3. A composition according to claim 2 wherein said amount is about 5-40%.

4. A composition according to claim 1 which is about 1-50% crosslinked.

5. A composition according to claim 1 which is a crosslinked hydrolyzed product of poly(2-ethyl-2-oxazoline).

6. A composition according to claim 1 which is a crosslinked random copolymer composed of the hydrolyzed unit of ethyleneimine and an unhydrolyzed unit of N-propronyl ethyleneimine.

7. A composition of claim 1 wherein the crosslinking agent is a polyaziridine, a polyepoxide, a melamine/formaldehyde, a polycarboxylic acid, ammonium zirconium carbonate, or a polyaldehyde.

8. A composition according to claim 1 in admixture with a film-forming polymer.

9. A composition of claim 7 wherein said film-forming polymer is polyvinyl alcohol, polyvinyl pyrrolidone, gelatin, polyurethane, latex or cellulose.

10. A color printable substrate according to claim 1 having the composition of claim 1 coated thereon.

11. A method of making the composition of claim 1 which comprises hydrolyzing poly(2-alkyl-2-oxazoline) and crosslinking the hydrolyzed product.

12. A method according to claim 11 wherein the hydrolyzing step is carried out in acid or base.

13. A method according to claim 12 wherein crosslinking is effected by coating the hydrolyzed product onto a substrate and optionally heating.

14. A composition of claim 1 which is in the form of an aqueous solution or hydrogel.

15. A composition of claim 1 which is substantially free of propionic acid.
